(19) United States
(12) Patent Application Publication
(10) Pub. No.: US 2007/0112603 A1
(43) Pub. Date: May 17, 2007

(54) Digital data entry methods and devices

(75) Inventors: Darrell Kauthen, Littleton, CO (US); Alexis Porras, Lexington, MA (US); Ravi Kalathil, Boston, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Fresenius Medical Care Holdings, Inc., Lexington, MA (US)

(21) Appl. No.: 11/591,438

(22) Filed: Nov. 1, 2006

Related U.S. Application Data
(60) Provisional application No. 60/732,335, filed on Nov. 1, 2005.

(51) Int. Cl. G09G 5/00; G06F 19/00; G06F 17/00

(52) U.S. Cl. 705/3; 345/173; 715/780

(57) ABSTRACT

The invention provides methods and devices for data entry, particularly with respect to patient care and medical treatment data. In one aspect, a data entry device according to the invention includes a touch screen for entering patient data during a treatment session and a digital processor for managing the display (e.g., of prompts) on the touch screen, as well as the input, display, communication, collection and/or storage of the entered data. In these regards, for example, the processor (or other apparatus associated with the data entry device) can be adapted for wired or wireless communication with other such devices, databases, servers or otherwise, as well as with medical treatment apparatus, such as dialysis machines.

### BACKGROUND OF THE INVENTION

This application claims the benefit of filing of U.S. Patent Application Ser. No. 60/732,335, filed Nov. 1, 2005, entitled, Digital Data Entry Methods and Devices, the teachings of which are incorporated by reference herein.

Dialysis is an important treatment regimen for a variety of chronic diseases. To meet the need for regular care, patients typically travel to hospitals or dialysis centers that are designed for efficient and routine dialysis therapy. Dialysis centers, for example, often have multiple dialysis stations, each including one or more chairs or beds equipped for providing dialysis treatment to a patient. A nurse or patient care technician (PCT) oversees the treatment sessions and records patient information, such as, patient vitals, treatment details and billing information.

Like other health care facilities, one difficulty that dialysis treatment centers may encounter is the large amount of data that must be entered and recorded. For each patient, a health care provider must record, for example, blood pressure, pulse, and select treatment parameters. In addition, the identification of the health care provider, identity of the patient, scheduling information, and billing information must be coordinated. To assist with data entry, computers have been utilized—though, typically only to memorialize data recorded on paper records or charts in the first instance.

Thus, for example, a single data entry station or set of stations may be provided for entering all patient data at a given health center. This or these may be disposed at a nursing station, a “back office” billing and record keeping room, or otherwise. Indeed, such computers may be disposed adjacent patient treatment stations.

Regardless, conventional implementations result in data errors and/or cumbersome data entry procedures. For example, a number of entry codes must be memorized and the procedure for switching between patients can require excessive keystrokes. As a result, health care providers spend a lot of time entering data that could otherwise be used for patient care. In addition, if the data entry station is not ergonomically designed, data entry can result in repetitive stress disorders.

Conventional data entry stations can also create problems in a medical setting. For example, the keyboards used to enter data can become a breeding ground for infectious agents. Keyboards are difficult to properly clean and can spread dangerous pathogens.

An object of the invention is to provide improved methods and apparatus for health care provision.

A related object is to provide such methods and apparatus as improve data entry in connection with health care provision.

A further object is to provide such methods and apparatus as can be used in connection with dialysis treatment and/or otherwise in the provision of health care.

A still further object is to provide such methods and apparatus as provide for efficient data entry and, yet, minimize the time required to enter patient information while protecting against the spread of infectious agents.

### SUMMARY OF THE INVENTION

The foregoing are among the objects achieved by the invention, aspects of which provide methods and devices for data entry, particularly with respect to patient care and medical treatment data. In one such aspect, a data entry device according to the invention includes a touch screen for entering patient data during a treatment session and a digital processor for managing the display (e.g., of prompts) on the touch screen, as well as the input, display, communication, collection and/or storage of the entered data. In these regards, for example, the processor (or other apparatus associated with the data entry device) can be adapted for wired or wireless communication with other such devices, databases, servers or otherwise, as well as with medical treatment apparatus, such as dialysis machines.

The touch screen allows, for example, for data entry without the need for a keyboard. The operator (e.g., patient care technician, nurse or other health care provider) can touch keypad and/or button icons on the touch screen to sign-in, to call up patient information, and/or to record patient data. Unlike conventional systems, the use of a touch screen greatly reduces the risk of patient infection and facilitates cleaning/sterilization.

Further aspects of the invention provide such a data entry device adapted to reduce the number of steps required to input information and to reduce the chance of incorrect data entry (e.g., as might result when the operator is confused about which patient data is being entered).

In one such aspect, the data entry device is associated with—and physically disposed between—at least two beds or, for example, in the dialysis treatment center setting, two dialysis treatment stations (e.g., dialysis “chairs”). To avoid operator confusion the digital processor can drive the touch screen so as to provide visual cues that match the physical setting and that facilitate selecting which of the two treatment stations (and/or associated patients) for which data is to be entered.

When the data entry device is positioned between treatment stations, icons for selecting the treatment station to the left of the device can be shown on the left side of the screen and icons for selecting the treatment station to the right of the device can be shown on the right side of the screen. The screen can additionally show photographs of the patients that are being treated at the respective stations (the location of the patient photograph can also be coordinated with the physical location of the patient.). The operator can use those photographs to determine if the information being entered is associated with the correct patient.

Alternatively, or additionally, according to aspects of the invention the display rendered by the data entry device in connection with the input of data for each of the respective treatment stations/patients can be associated with a different color scheme. For example, when a data entry field is displayed for a first patient the color scheme of the screen can be blue-based and when a data entry field is displayed for a second patient the color scheme of the screen can be green-based.

To further reduce the chance of incorrect data entry, in another related aspect of the invention, the processor automatically uploads patient treatment data from the medical treatment apparatus (e.g., dialysis machine), thereby relieving the operator of this responsibility and the attendant risk of error.

To this end, in some related aspects of the invention, the digital processor generates a session identifier (e.g., a unique number) at initiation of each new treatment session and/or upon operator selection of a treatment station for display and/or entry of data during an on-going session. That identifier can be compared with a like or related identifier generated by, or assigned to, the medical treatment apparatus (e.g., dialysis machine) and communicated between it and the data entry device wirelessly, via an attached digital data processor cable, or otherwise. The data entry device and/or the medical treatment apparatus blocks automatic uploading of patient data until those identifiers match or otherwise compare favorably.

Moreover, to ensure that the operator remains alert to patient status, the processor requires operator interaction (e.g., the operator must touch a button on the touch screen) in order to complete such an upload.

In a related aspect of the invention, if an automatic transfer fails, the operator may manually enter the treatment information from the dialysis machine into the data entry device.

In another aspect, the data entry device can include keypad and/or button icons that facilitate data entry. In one aspect, the displayed icons are specific to the data being entered, e.g., in an activated data entry field. For example, where a numeric data entry field is selected by the operator, a keypad with only numbers (and no letters) can be shown. Conversely, if letters are needed, a full keyboard (e.g., an alphanumeric keypad) can be shown (e.g., with letters and numbers).

In still another aspect, the data entry device can display a keypad with “quick” keys that facilitate entering data or other values predicted for a given patient, treatment, setting or otherwise. Rather than (or in addition to) showing, for example, quick keys that facilitate entering “typical” standard values on a given entry screen, the device can display keys with values specific to a given patient, at a given time, etc. The predictive values can be chosen based on previous patient data and/or normal patient values.

These and other aspects of the invention relating to patient care are evident in the drawings and in the detailed description that follows.

### BRIEF DESCRIPTION OF THE ILLUSTRATED EMBODIMENT

A more complete understanding of the invention may be attained by reference to the drawings, in which:

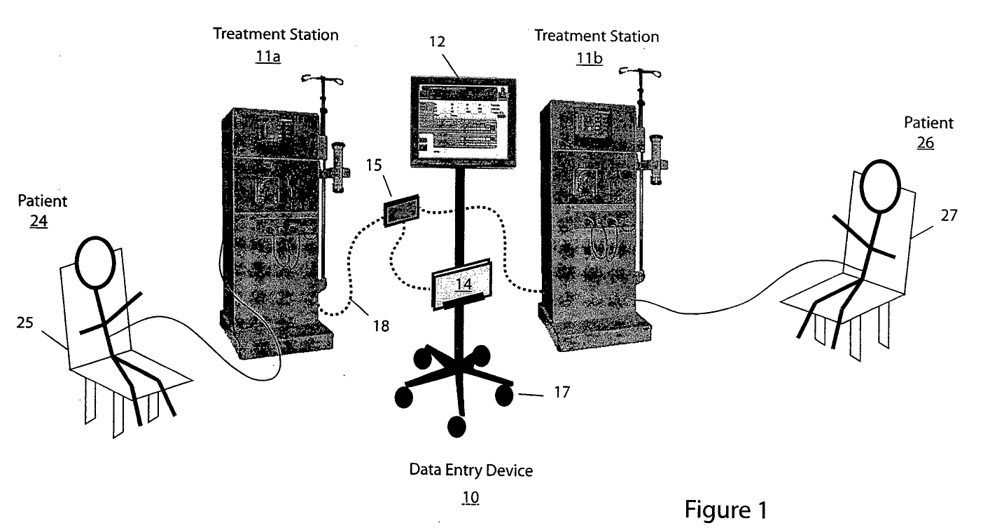

FIG. 1 depicts a digital data entry device according to the invention, as well as medical treatment apparatus (e.g., dialysis machines), with which such device may be used;

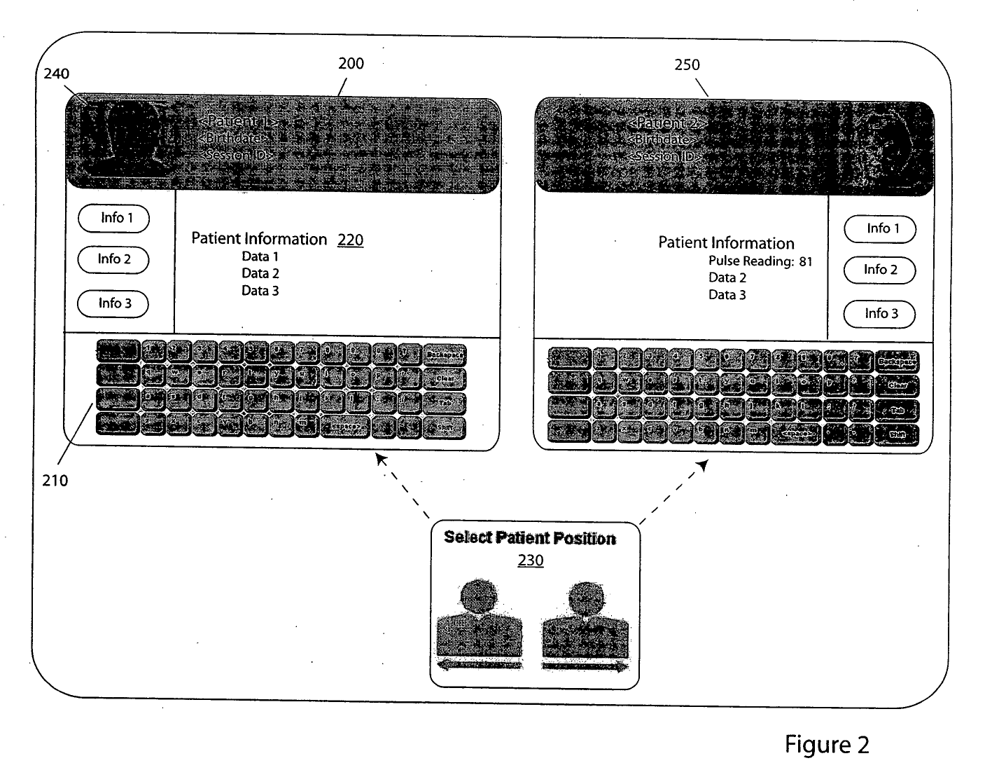

FIG. 2 depicts a touch screen display of a digital data entry device according to the invention that facilitates selection of a patient for which treatment data is to be entered or displayed;

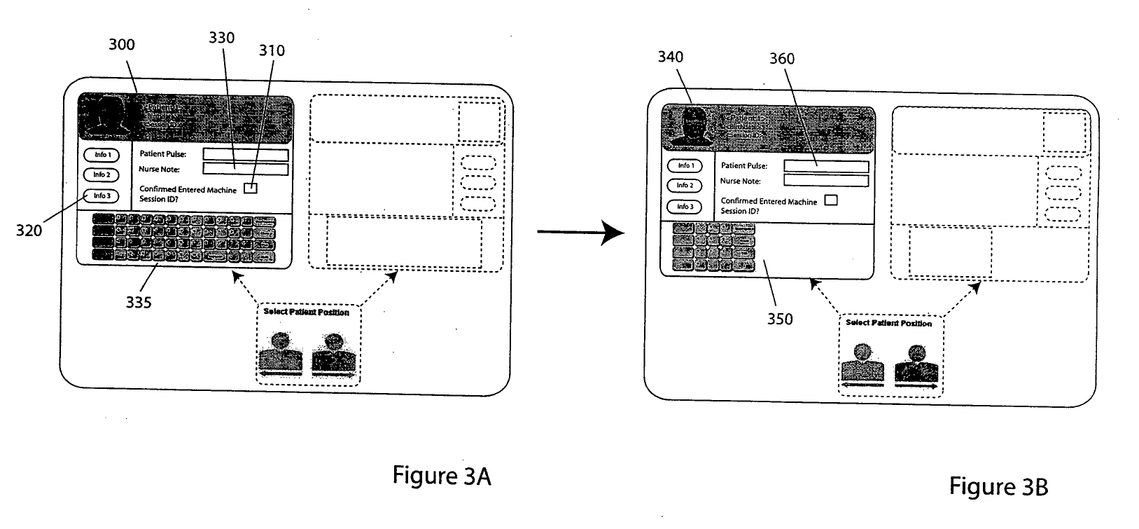

FIGS. 3A-3B depict further touch screen displays of a digital data entry device according to the invention wherein a data entry widget corresponds to the type of data to be entered;

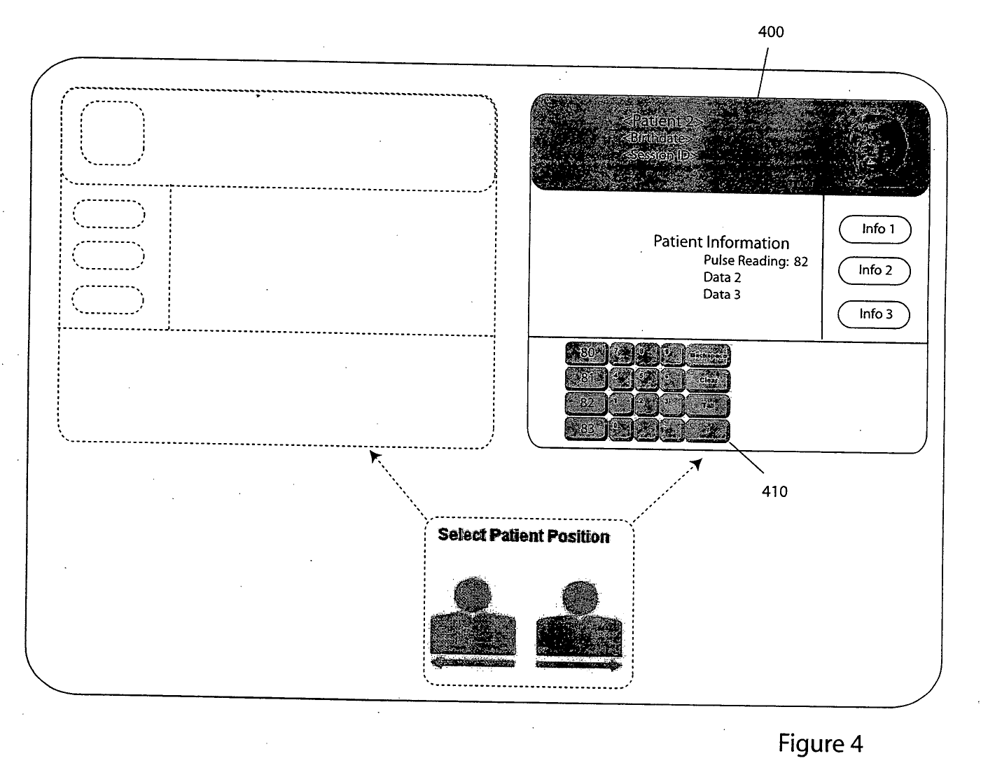

FIG. 4 depicts a touch screen display of a digital data entry device according to the invention wherein the keypad displayed has icons/buttons corresponding to likely operator input;

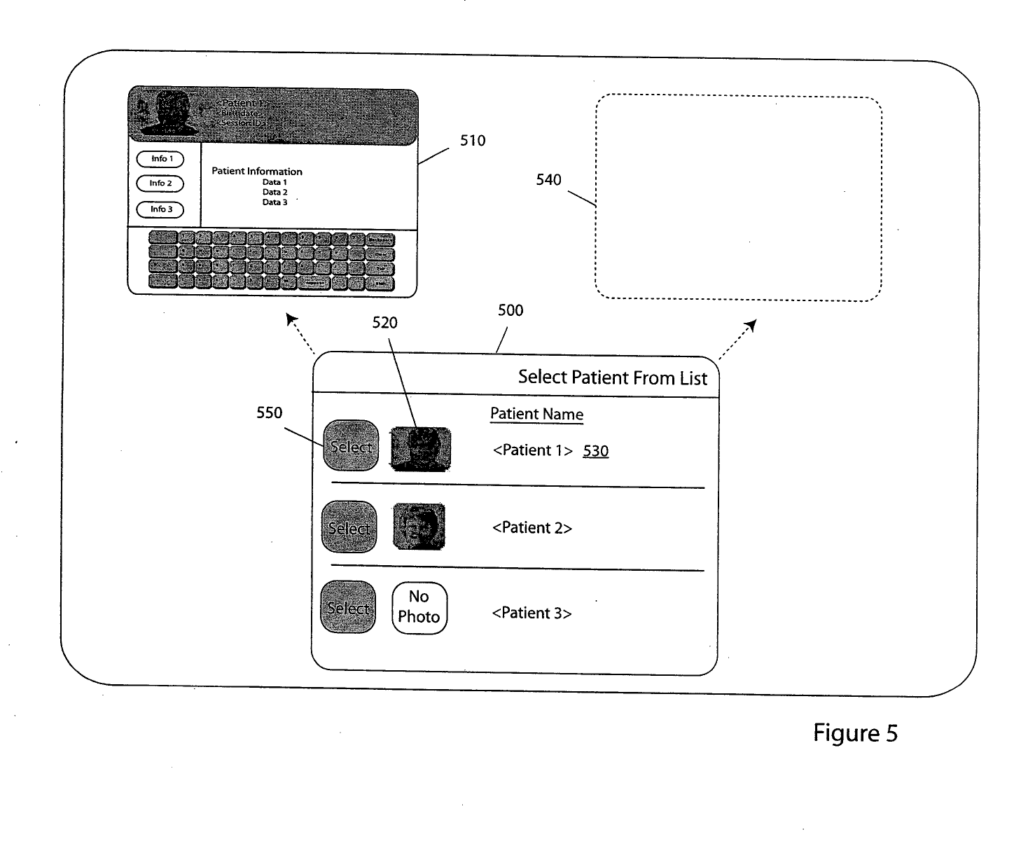

FIG. 5 depicts a touch screen display of a digital data entry device according to the invention that facilitates selection of a patient for which treatment data is to be entered or displayed; and

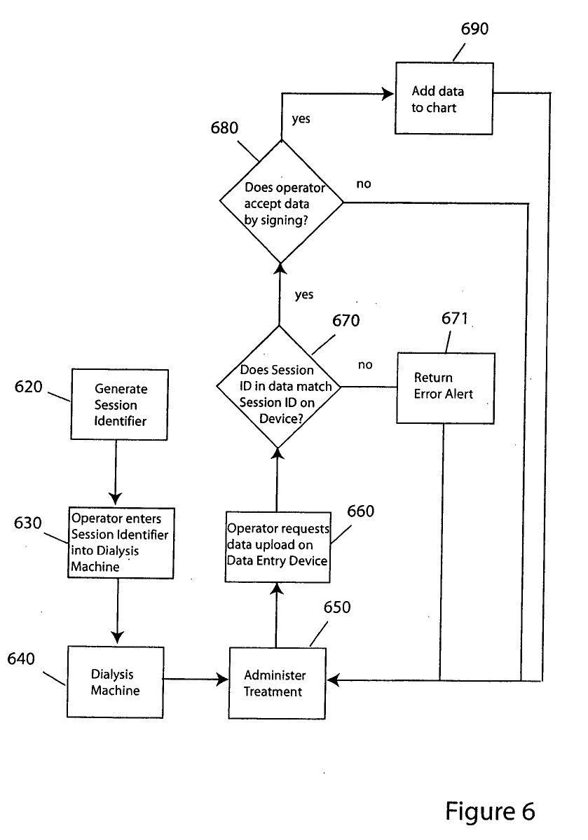

FIG. 6 depicts a workflow for data upload in a system according to the invention.

### DETAILED DESCRIPTION OF THE ILLUSTRATED EMBODIMENT

Described herein are methods and devices for entry of digital data in connection with medical treatment and patient care, particularly, by way of non-limiting example, in the context of dialysis centers—though applicable in a range of health care settings. In one embodiment, the device described herein includes a data entry station (or “data entry device”) 10 comprising (a) a touch screen 12 that provides a visual and tactile interface with a user and (b) a digital processor 14 that controls the touch screen (e.g., vis-à-vis the display of prompts, as well as the input, display, communication, collection and/or storage of the data therefrom and thereto), and that interfaces with other such devices, databases, servers or otherwise, as well as with medical treatment apparatus, such as dialysis machines. Unlike conventional data entry stations, the data entry station 10 does not require a keyboard. This greatly reduces the risk of patient infection. In addition, the touch screen 12 interface and the method of data entry reduce the number of steps required to enter data and are designed to reduce the chance of error, e.g., when a single data entry station is associated with more than one patient.

FIG. 1 illustrates a data entry station 10 according to one practice of the invention. As shown, the station 10 is associated with two medical treatment apparatus (here, dialysis machines) 11a and 11b of the type commonly known in the art. The station 10 is disposed between the apparatus (or otherwise adjacent thereto) for use by a nurse, patient care technician (PCT) or other health care provider in recording patient treatment information, e.g., administered by the apparatus 11a, 11b. Although only two apparatus 11a, 11b are shown, those skilled in the art will appreciate that the data entry station 10 may support more than two such apparatus.

The station 10 comprises a touch screen display 12, digital data processor 14, and adapter 15, as shown. The touch screen display 12 comprises a conventional device of that type known in the art for visual and/or tactile interface with an operator—here, a nurse, patient care technician or other health care provider—operated in accord with the teachings hereof. The unit 12 can be based on liquid crystal display technology, cathode ray display technology, or otherwise. Though the illustrated embodiment relies on color display technology, other embodiments may utilize monochrome (e.g., employing shading, hashing, or other visual indicators in place of the colorations discussed below). The display 12 is sized and provides resolution sufficient to display and collect information of the type described, or otherwise suitable for the digital data entry environment for which it is used. As evident in the discussion below, preferably the display is adapted for ready cleaning and/or sanitization.

The digital data processor 14 comprises an embedded processor, personal computer, workstation, minicomputer, mainframe or other digital data processing device of the type known in the art, as adapted in accord with the teachings hereof. The digital data processor 14 may be a stand alone device or may be integral to one or more other components of the illustrated system, e.g., the touch screen 12 and/or medical treatment apparatus 11a, 11b. It may, moreover, be coupled for communication with the touch screen display 12 via wireless connection (e.g., BlueTooth, 802.1x, or otherwise), wired connection (Ethernet, backplane bus) or otherwise, all in the conventional manner known in the art.

In the illustrated embodiment, operation of the data entry device 10 in general, and of the touch screen 12, in particular, are controlled by the processor 14. To this end, and to the extent that the description which follows attributes control and data processor functionality to the touch screen 12 (in particular, or the data entry device 10, in general), it will be appreciated that such control and data processing is provided indeed by the processor 14.

The adapter 15 provides communication coupling between the digital data processor 14 (and, more generally, the station 10) and the medical treatment apparatus (here, dialysis machines) 11a, 11b. In the illustrated embodiment, the adapter 15 is a USB hub of the conventional type known in the art. In other embodiments, the adapter can take on other form factors (electrical and/or physical), such as Ethernet, serial cabling, and so forth, suitable for transmitting data to/from the station 10 and apparatus 11a, 11b. Moreover, illustrated adapter 15 can be supplanted by, or supplemented with, wireless communications (e.g., based on BlueTooth, 802.1x, and so forth), consistent with the aforesaid purpose. Regardless, the adapter 15 transmits data in a common protocol defined between the station 10 and treatment apparatus 11a, 11b. In the illustrated embodiment, the adapter is a stand-alone device that is coupled with the station 10 and apparatus 11a, 11b via cabling, as shown, though in other embodiments it may be integral with one of more of the other system components (e.g., the station 10 and/or apparatus 11a, 11b).

In the illustrated embodiment, the display 12 and processor 14 make up the data entry station 10 and are disposed together on a rolling stand, as shown, for portability; though in other embodiments they may be more fully portable (e.g., lightweight and with carrying handles), fixed (e.g., wall- or cabinet-mounted) or otherwise—all in the conventional manner of clinically-deployed medical data entry devices. Data entry station 10 can be adapted to provide an ergonomic work station, such that data entry puts a minimal stress on a user. The height and angle of the touch screen 12 facilitate data entry and minimize the risk of repetitive stress disorders. The height and angle of the touch screen 12 also make the screen less visible to a casual onlooker such as another patient or ambulance driver walking by, which helps protect the confidentiality of the patient data being displayed. The illustrated data entry station 10 is set to display a neutral screen saver after 30 seconds of system inactivity, to further protect the confidentiality of such patient data.

In the illustrated embodiment, the data entry device 10 is used in connection with the medical treatment apparatus 11a, 11b to facilitate dialysis treatment of patients 24, 26, as shown. Though illustrated patients 24, 26 are shown in chairs, those skilled in the art will appreciate that patients can receive treatment in prone or other positions, as well—all in the conventional manner known in the art.

Referring to FIG. 2, in the illustrated embodiment, the touch screen 12 operates under control of processor 14 to provide a keyboard icon 210, which the operator can use to input letters, numbers, and/or other symbols for recording patient information. As shown in FIG. 3, the touch screen 12 can additionally, or alternatively, display text boxes 330, check boxes 310, button icons 320 or other widgets that the operator can use to make input designations. Together, the icons 210, 310-330 (and others displayed on screen 12) can be used to select and/or enter pre-treatment information (e.g., patient and/or operator identification), treatment information (e.g., blood pressure, pulse, treatment parameters), and post-treatment information (e.g., next scheduled patient visit, drug prescriptions, and so forth).

When more than one dialysis chair (or other medical treatment apparatus 11a, 11b) is associated with a data entry station 10, the operator can select a particular patient and/or apparatus using pop-up window or icon 230 (or other selector) displayed on screen 12 (e.g., by action of processor 14). Conventional systems often require burdensome procedures for selecting patients and/or switching between patients and may not clearly indicate the chosen patient. Conversely, the devices and methods described herein provide simple procedures for selecting patients and reduce the risk of confusion regarding the selection. For example, as shown in FIG. 2, the processor 14 uses a patient's physical position with respect to data entry device 10 to display on touch screen 12 a graphical prompt (such as, by way of non-limiting example, an icon) to assist the operator with patient selection.

Thus, a patient 26 to the right of the device 10 (from the vantage of the operator who is using the touch screen 12 for data access or entry) can be selected by touching an icon on the right side of the screen 230. Conversely, a patient to the left 24 (again, from the vantage of such an operator) can be selected by touching an icon on the left side of the screen 230.

With further reference to FIG. 2, in some embodiments, the icon 230 (or other graphical prompt) can occupy a substantial entirety of the display of touch screen 12 (e.g., to the exclusion of patient data screens 200, 250), e.g., at start-up, during periods of inactivity, or following the close of all treatment sessions. When the patient designator on either side of the prompt 230 is selected, the corresponding patient data screen 200, 250 is activated and occupies the display. In other embodiments, the prompt is displayed at all times, along with one or both patient data screens 200, 250, such that selection of a given patient designator (e.g., on the left or right side of the prompt) activates (e.g., highlights) the corresponding screen 200, 250 and deactivates (e.g., grays out) the other screen 200, 250.

Though the illustrated embodiment uses left and right orientations to assist the operator with patient selection, other embodiments may use other orientations (such as upper and lower), instead or in addition. Moreover, while the illustrated embodiment uses the orientation of an icon or graphical prompt to assist the operator in patient selection, data entry fields, themselves, may be oriented on the touch screen in accord with the corresponding patient's position (from the vantage point of the operator).

In addition to the physical location of the patient (or treatment apparatus 11a, 11b), the devices and methods described herein can use other features to indicate the patient and/or apparatus for data entry. In one embodiment, illustrated in FIG. 2, a patient's photograph 240 can be shown when their corresponding patient data screen 200, 250 is activated. An operator can use the photograph to confirm that the data being entered corresponds to the correct patient record.

In addition to patient photographs, color schemes can be used to help reduce the chance of operator error. For example, in the illustrated embodiment, the patient data screens 200, 250 have different color schemes, e.g., green for screen 200 and blue for screen 250. Preferably, those color schemes correspond to visual cues in the treatment environment (e.g., differing colors of patient tags, clothing, chairs or bed, treatment apparatus, or otherwise) The color scheme can be used as yet another reference during data entry for determining/confirming which patient record has been selected for data entry.

One skilled in the art will appreciate that a variety of patient information can be entered with the methods and devices described herein and that the display on the touch screen 12 can be adapted depending on the intended use. To facilitate data entry and reduce risk of operator error using touch screen 12, the processor 14 can render only necessary keypad and/or button icons on the touch screen 12. Thus, where data entry for an input field selected by the operator (or otherwise activated) requires only numeric values, the processor 14 renders only a numeric keypad 350 on the display 12. Conversely, where an alphanumeric input field is selected by the operator (or otherwise activated), the processor 14 renders a full (alphanumeric) keypad 350 on the display 12. As the operator moves from one data entry type to another, the processor 14 changes the icons (or data entry widgets), as necessary. FIGS. 3A and 3B illustrate that even within the same patient data screen, the icons can be field-specific. For example, referring to FIG. 3A, when text entry widget 330 is activated, keyboard 335 is rendered by processor 14 on touch screen 12. Conversely, referring to FIG. 3B, when numeric entry field 360 is activated, keypad 350 is rendered.

FIG. 4 illustrates that the keypad 410 and/or button icons can have a predictive feature based on previously entered or expected patient information and/or the selected data field. For example, if the patient previously had a pulse of 81, the processor 14 can render “buttons” on the touch screen that are based on this value. For example the screen can include a numeric keypad 410 and buttons 410 for 80, 81, 82, and 83. If the patients pulse is 82 bps, the health care provider can touch 82. This predictive feature can reduce the number of steps required to enter patient data. Conversely, if the patient's pulse is not illustrated on one of the buttons, the health care provider can use the numeric keypad 410 to enter a different value. One skilled in the art will appreciate that the predicted values can be chosen with a variety of schemes that extrapolate, average, and/or rank values based on previous patient data and/or on “normal” patient values.

FIG. 5 illustrates a display driven by processor 14 to touch screen 12, e.g., at the start of a treatment session, to facilitate selection of a patient whose data will be displayed and/or entered via patient data screen 510 during that session. The touch screen 12 displays a list of available patients 500 (e.g., who have previously been treated by the operator and/or at the health care facility) with the patient's picture disposed adjacent to their corresponding names in the list. By way of non-limiting example, in the illustrated embodiment, the operator selects the patient by touching the “select” button 550 next to the patient's picture 520. However, those skilled in the art will appreciate that the method for selecting the patient from the list may vary (e.g., the operator may touch the patient picture 520 or name 530). A similar list can be displayed for selection of patient data for other patient data screens 540.

FIG. 6 is a system flow diagram illustrating the use of session identifiers by processor 14 (and, more particularly, data entry device 10) to avoid erroneous data upload. As shown in the drawing, the operator 600 activates the data entry device 610 (same as device 10 discussed above) at the start of a treatment session and/or upon operator selection of a patient. The processor 14 generates a session identifier (e.g., a unique number and/or text string)—see step 620—and displays it on the touch screen 12. The operator enters the session identifier into the dialysis machine 640—see step 630—and the dialysis treatment session begins; see step 650.

When the operator subsequently requests a transfer of patient data (e.g., blood pressure) from the treatment apparatus (here, dialysis machine 640), step 660, the processor 14 compares the session identifier that had been generated in step 620 with that which had been entered in the machine in step 630 (and passed back to the processor 14, e.g., via adapter 15 and associated cabling 18, at initiation of an upload). If the compared session identifiers, do not match, an error 671 is returned to the operator 600. By way of non-limiting example, the touch screen 12 flashes red (see step 671) until the operator 600 acknowledges the error. By checking that the session identifiers generated in step 620 and entered in step 630 match, the data entry device reduces the chance that data from the wrong dialysis machine 640 will be entered into a patient record. In this way, the machine session identifiers link the stream of data from the dialysis machine for a given treatment session to one patient record, eliminating errors that could arise from inadvertently swapped cables, PCT error, machine error, and so forth.

In a preferred embodiment, even if the session identifiers 620 and 630 do match, and an error is not returned, the processor 14 still requires further operator 600 interaction to complete the upload. To this end, it checks to see whether the operator has accepted the data, e.g., by electronically “signing it” or otherwise; step 680. By way of non-limiting example, the operator 600 can so accept the data by touching a button on the touch screen display 12, signing with an electronic pen, and so forth. In some embodiments, the processor 14 displays at least a portion of the uploaded data (e.g., blood pressure, electrolyte levels, or other critical indicators) before permitting operator acceptance. This added operator interaction requirement is unlike other systems, which would traditionally complete the upload automatically without operator interaction. By requiring operator sign-off (or other acceptance), the illustrated embodiment reduces the chance of error and provides improved patient safety measures. In the illustrated embodiment, once the operator 600 accepts the data, processor 14 adds the data to patient's chart/record 690 in the conventional manner known in the art. In the illustrated embodiment, this includes filling in one or more of the data entry fields on the patient data screen).

Even if the operator does not accept the data and/or if the data transfer fails, e.g., on account of equipment failure, the operator 600 may enter the treatment information in the touch screen 12 via a keyboard or other widget, as discussed above.

A more complete understanding of the invention may be attained by reference to aforementioned incorporated-by-reference patent application Ser. No. 60/732,335, filed Nov. 1, 2005, entitled, Digital Data Entry Methods and Devices.

Described above are devices and methods meeting the aforementioned objects, among others. Those skilled in the art will appreciate that the embodiments discussed and shown herein are merely examples of the invention and that other embodiments fall within the scope thereof. Thus, by way of non-limiting example, it will be appreciated that a digital data entry station of the type describe above can be used with a variety of medical treatment and diagnostic apparatus, in addition to dialysis machines. By way of further example, it will be appreciated that, in some embodiments (e.g., where sanitary conditions are of less concern and/or are compensated for in other ways), the touch screen can be replaced by a conventional display (e.g., CRT, LCD or otherwise) and a keyboard. In view thereof,

What we claim is:

1. Digital data apparatus for patient data entry in a patient care setting, comprising
A. a touch screen that accepts data regarding at least one patient,
B. the touch screen displaying, using visual cues that match one or more aspects of the patient care setting, one or more patient data entry prompts and/or patient data entry fields.

2. The apparatus of claim 1, wherein the touch screen displays one or more data entry prompts and/or data entry fields for a given patient in an orientation that corresponds to a location of the patient relative to the touch screen from the vantage of an operator who is using the touch screen for at least one of patient data access and patient data entry.

3. The apparatus of claim 1, wherein
A. the touch screen displays, in a left orientation, one or more data entry prompts and/or data entry fields for a patient, if any, disposed to a left of the touch screen relative to an operator who is using the touch screen for at least one of patient data access and patient data entry,
B. the touch screen displays, in a right orientation, one or more data entry prompts and/or data entry fields for a patient, if any, disposed to a right of the touch screen relative to an operator who is using the touch screen for at least one of patient data access and patient data entry.

4. The apparatus of claim 1, wherein
A. the touch screen displays, as a patient data entry prompt, a keypad,
B. the touch screen varies the symbols on that keypad vary in accord with a patient data entry field that is activated.

5. The apparatus of claim 4, wherein the touch screen displays, as a patient data entry prompt, a numeric keypad when a numeric data entry field is activated.

6. The apparatus of claim 4, wherein the touch screen displays, as a patient data entry prompt, an alphanumeric keypad when an alphanumeric data entry field is activated.

7. The apparatus of claim 1, wherein
A. the touch screen displays, as a patient data entry prompt, a keypad,
B. the touch screen varies the symbols on that keypad vary in accord with any of expected and predicated values for a patient data entry field that is activated.

8. The apparatus of claim 1, wherein
A. the touch screen accepts data regarding two or more patients,
B. the touch screen displays, in a first orientation, one or more data entry prompts and/or data entry fields for a patient disposed in a first direction relative to the touch screen from the vantage of an operator who is using the touch screen for at least one of patient data access and patient data entry,
C. the touch screen displays, in a second orientation, one or more data entry prompts and/or data entry fields for a patient disposed in a second direction relative to the touch screen from the vantage of an operator who is using the touch screen for at least one of patient data access and patient data entry.

9-15. (canceled)

16. Digital data apparatus for patient data entry in a patient care setting, comprising
A. a touch screen that accepts data regarding at least two patients,
B. the touch screen displaying, using visual cues that match one or more aspects of the patient care setting, one or more patient data entry prompts and/or patient data entry fields for each patient,
C. wherein the visual cues include displaying one or more data entry prompts and/or data entry fields for each patient using a color scheme associated with that patient.

17. The apparatus of claim 16, wherein the touch screen displays one or more data entry prompts and/or data entry fields for a given patient using a color scheme associated with one or more aspects of the patient care setting for that patient.

18. The apparatus of claim 16, wherein the touch screen displays one or more data entry prompts and/or data entry fields for a given patient using a color scheme associated with one or more of a tag, clothing, treatment chair, bed, and treatment apparatus for the patient.

19-23. (canceled)

24. The apparatus of claim 1, wherein
A. the touch screen that accepts data regarding at least two patients,
B. wherein the visual cues include displaying a picture of each patient along with the one or more data entry prompts and/or data entry fields for that patient.

25-27. (canceled)

28. The apparatus of claim 1, wherein
A. the touch screen displaying a list of patients, wherein the list includes, for at least one such patient, a picture of that patient,
B. the touch screen responding to selection of a patient from the list by displaying one or more patient data entry prompts and/or patient data entry fields for that patient.

29. Digital data apparatus for patient data entry in a patient care setting, comprising
A. a touch screen,
B. medical apparatus for any of treatment and/or diagnosis of a patient,
C. a digital processor, in communications coupling with the touch screen and with the medical apparatus, the digital processor
(i) causing the touch screen to display one or more patient data entry prompts and/or patient data entry fields,
(ii) selectively uploading patient data from the medical apparatus,
D. the digital processor responding to operator acceptance for completing the uploading.

30. The apparatus of claim 29 wherein the digital processor completes one or more data entry fields with the uploaded patient data.

31. The apparatus of claim 29, wherein the processor generates a session identifier and causes it to be displayed on the touch screen.

32. The apparatus of claim 31, wherein the processor compares the session identifier generated by it with a session identifier provided by the medical apparatus.

33. The apparatus of claim 32, wherein the processor prevents uploading of the patient data from the medical apparatus in instances where the session identifier generated by the processor do not favorably compare with the session identifier provided by the medical apparatus.

34. The apparatus of claim 29, wherein the processor permits the operator to enter data into one or more of the data entry fields regardless of a success of the upload of patient data.

35. A method of patient data entry in a patient care setting, comprising
A. accepting, with a touch screen, data regarding at least one patient,
B. displaying on the touch screen, using visual cues that match one or more aspects of the patient care setting, one or more patient data entry prompts and/or patient data entry fields.

36-40. (canceled)

41. A method of patient data entry in a patient care setting, comprising
A. providing a touch screen,
B. providing medical apparatus for any of treatment and/or diagnosis of a patient,
C. providing a digital processor in communications coupling with the touch screen and with the medical apparatus,
D. with the digital processor
(i) causing the touch screen to display one or more patient data entry prompts and/or patient data entry fields,
(ii) selectively uploading patient data from the medical apparatus,
E. responding, with the digital processor, to operator acceptance for completing the ploading.
